(19) United States
(12) Patent Application Publication
(10) Pub. No.: US 2008/0155091 A1
(43) Pub. Date: Jun. 26, 2008

(54) REMOTE MONITORING IN A COMPUTER NETWORK

(76) Inventors: Parag Gokhale, Ocean, NJ (US); Rajiv Kottomtharayil, Marlboro, NJ (US); Srinivas Kavuri, South Plainfield, NJ (US); Anand Prahlad, East Brunswick, NJ (US); Suresh Parpatakam Reddy, Marlboro, NJ (US); Robert Keith Brower, Atlantic Highlands, NJ (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/615,512

(22) Filed: Dec. 22, 2006

(51) Int. Cl. G06F 15/173

(52) U.S. Cl. 709/224

(57) ABSTRACT

Systems and methods for providing automated problem reporting in elements used in conjunction with computer networks are disclosed. The system comprises a plurality of elements which perform data migration operations and a reporting manager which monitors the elements and data migration operations. Upon detection of hardware or software problems, the reporting manager automatically communicates with elements affected by the problem to gather selected hardware, software, and configuration information, analyzes the information to determine causes of the problem, and issues a problem report containing at least a portion of the selected information. The problem report is communicated to a remote monitor that does not possess access privileges to the elements, allowing automated, remote monitoring of the elements without compromising security of the computer network or elements.

### BACKGROUND OF THE INVENTION

1. Field of the Invention

The invention relates to problem reporting in a computer network and, in particular, pertains to remote monitoring of a data storage system.

2. Description of the Related Art

Data migration systems are routinely utilized in computer networks to perform data migration operations on electronic data stored within the network. In general, primary data, comprising a production copy or other “live” version in a native format, is generally stored in local memory or another high speed storage device that allows for relatively fast access. Such primary data is generally intended for short term retention, on the order of hours or days. After this retention period, some or all of the data is stored as one or more secondary copies, for example, to prevent loss of data in the event that a problem occurs with the data stored in primary storage. Secondary copies are generally intended for longer-term storage, on the order of weeks to years prior to being moved to other storage or discarded. Secondary copies may be indexed so that a user may browse and restore the data at a later point in time. In some embodiments, application data, over its lifetime, moves from more expensive quick access storage to less expensive, slower access storage. An example of a data migration system which performs data migration operations on electronic data is the QiNetix storage management system by CommVault Systems of Oceanport, N.J.

While data migration systems function to preserve data in the event of a problem with the computer network, the data migration systems themselves may encounter difficulties in storing data. For this reason, human monitors may be used to observe the data migration system and intervene to resolve problems which arise. Often, these monitors are experts, employed by the data migration system provider, conversant in the operation of the data migration system and capable of gathering information from the system, diagnosing problems, and implementing solutions.

This conventional monitoring is problematic, though. Problem resolution requires laborious, manual gathering of information necessary to diagnose and troubleshoot problems, increasing the time and cost associated with problem resolution. Additionally, much of the information gathered is often for points in time which are not required for problem resolution.

Furthermore, as the monitors of the data migration system may be employees of the data migration system provider, rather than the owner of the data migration system, the monitors are typically located remotely from the system. The remote monitors must therefore remotely access to the network in order to gather information for problem resolution. Security measures against unauthorized intrusion, such as firewalls and other technologies, though, restrict the access privileges remotely allowed to the data migration system. Lowering or reducing these defenses to allow remote monitors the access necessary to gather troubleshooting information may compromise the security of the data migration system and the computer network it serves. It is also undesirable to allow individuals who are not employed and supervised by the owner of the data migration system access to the archived data within the data migration system. For example, a medical or financial institution may possess confidential information about its clients which, if accessed by unauthorized individuals, even inadvertently, may open the institution to significant liability. Conversely, however, without sufficient access privileges, the monitors' ability to obtain the information required for problem resolution is limited, prolonging the time required to resolve problems as a result.

These deficiencies in the current monitoring of data migration systems illustrate the need for improved systems and methods for storage monitoring, in particular remote monitoring, and other improvements discussed below.

### SUMMARY OF THE INVENTION

The aforementioned needs are satisfied by the automated problem reporting system and methods of the present invention. In one embodiment, the invention provides a method of problem reporting in a computer network, such as a tiered data storage network. The method comprises monitoring a plurality of elements which perform data migration operations, detecting a problem which occurs during the data migration operation, requesting information from the elements, assembling the requested information into a report; and providing the report to a human monitor which does not possess access privileges to the elements.

In another embodiment, the invention provides a method of remotely monitoring the data migration operations within a computer network. In a first step, the method comprises providing a plurality of elements, comprising at least one of hardware, software, and firmware components which perform data migration operations. In a second step, the method also comprises monitoring at least one of log files generated by the elements, communications links between the elements, and configurations of the elements during the data migration operations to detect errors in the data migration operations. In a third step, the method further comprises gathering and analyzing selected information from the monitored elements automatically in response to the detection of an error in a data migration operation. In a fourth step, the method additionally comprises communicating the selected information to a remote monitor.

In a further embodiment, the invention provides a system for remote monitoring of a data migration operation occurring within a computer network. The system comprises a plurality of elements which perform data migration operations and a reporting manager which communicates with the elements to detect problems occurring within data migration operations. The reporting manager gathers information from the elements in response to a detected problem, where at least a portion of the gathered information is provided to a remote monitor which does not possess access privileges to the elements.

In an additional embodiment, the invention provides an automated problem reporting data migration system. The system comprises a client computer containing data, a plurality of storage media for storing the data, a storage manager which coordinates data migration between any of the client computers and storage media, a media agent which performs data migration operations in response to instructions from the storage manager, and a reporting manager which monitors data migration operations and generates reports containing selected information regarding the system hardware, software, and firmware in response to errors occurring during data migration. The reports are provided to a remote monitor which does not possess access privileges to the data migration system.

### BRIEF DESCRIPTION OF THE DRAWINGS

These and other objects and advantages will become more apparent from the following description taken in conjunction with the accompanying drawings.

FIG. 1 is a schematic illustration of one embodiment of a data migration system with automated problem reporting capability;

FIG. 2 is a flowchart illustrating one embodiment of a method of remote automated problem reporting;

FIG. 3 is a block diagram illustrating monitoring, detection, and reporting processes within the system of FIG. 1;

FIG. 4A is a schematic illustration of one embodiment of a problem report for distribution to a remote monitor; and

FIG. 4B illustrates one embodiment of a graphical display of at least a portion of the report received by the remote monitor.

### DETAILED DESCRIPTION OF THE PREFERRED EMBODIMENTS

Embodiments of the present invention relate to systems and methods of automated, remote monitoring and problem reporting in a data migration system for use with a computer network. However, embodiments of the invention may be applied to monitoring and problem reporting in any suitable network environment, whether the monitor is remotely or locally based. Examples include, but are not limited to, monitoring of network communication failures and hardware, software, and firmware failures.

In one embodiment, data migration systems include combinations of hardware, software, and firmware programs, as well communications links, necessary for performing data migration operations on electronic data within a computer network. One preferred embodiment of a data migration system is provided in U.S. patent application Ser. No. 11/120,619, entitled “HIERARCHICAL SYSTEMS AND METHODS FOR PROVIDING A UNIFIED VIEW OF STORAGE INFORMATION”, which is incorporated herein by reference in its entirety.

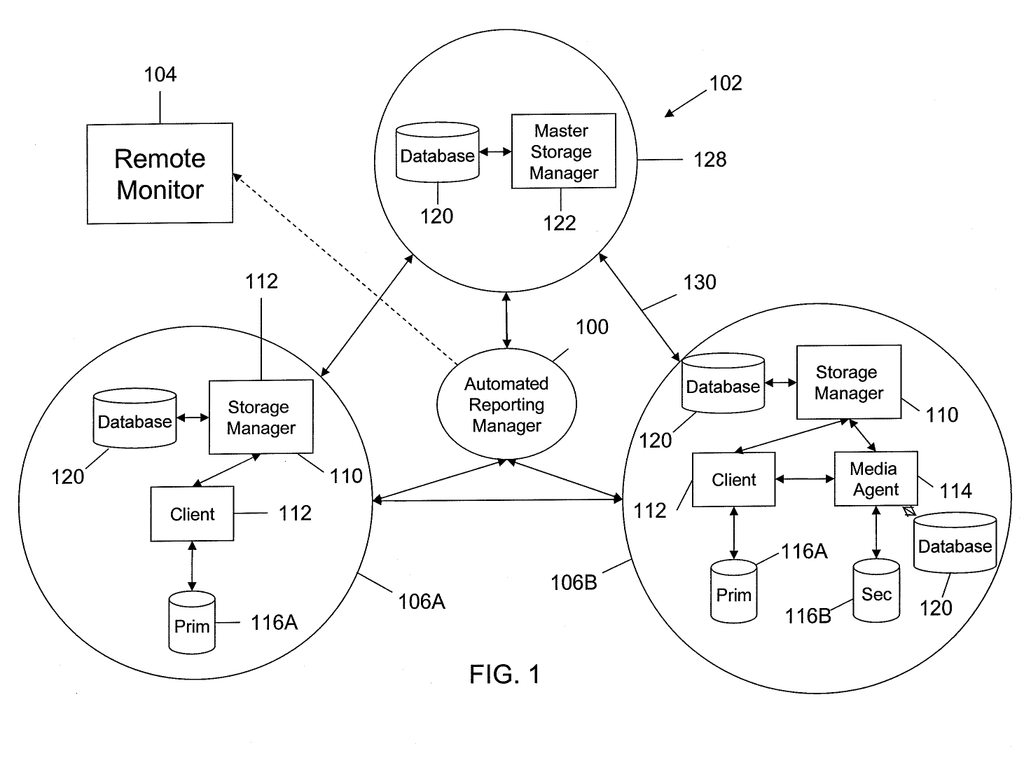

FIG. 1 illustrates one embodiment of a data migration system 102 with automated problem reporting capability for use in conjunction with a computer network. In one embodiment, the system 102 comprises a plurality of storage operation cells such as 106A, B (collectively, 106) and an automated reporting manager 100 which communicate through communication links 130. In general, the automated reporting manager 100 communicates with the cells 106 as they perform data migration operations. When the cells 106 detect a failure in one or more operations of a data migration process, an alert is issued to the reporting manager 100.

Based on the nature of the problem, the reporting manager 100 may determine which elements are involved in the failed data migration operation, where the elements may comprise hardware, software, or firmware components within the system 102. For example, the data migration of a Microsoft Exchange server may involve an Exchange server, a computer which manages the data migration hardware, and the reporting manager 100 itself. The reporting manager 100 may subsequently request information from these elements for analysis to ascertain the nature of the problem and extract of at least a portion of the received information pertinent to the failed process. Based on this pertinent information, the reporting manager 100 generates a report. Copies of the report are subsequently made available to a monitor 104, which in certain embodiments is a remote monitor 104.

Beneficially, no intervention is required on the part of the remote monitor 104 or the administrator of the data migration system 102 in generation of the report. In one aspect, this feature reduces the costs associated with problem resolution, as by automatically determining the information necessary for problem resolution, gathering the information, and analyzing the information, the system 102 performs tasks which would otherwise be performed by the monitor 104 and/or administrator. This allows problems to be identified and remedied more quickly than if the problems were manually identified, reducing the system 102 downtime. Furthermore, a greater portion of the monitor's 104 time may be spent developing solutions to problems, rather than gathering and analyzing the information. Additionally, by reducing the time necessary to identify and resolve problems, fewer monitors 104 may be necessary to support the system 102, reducing support costs.

In another aspect, the automated reporting capability enhances the security of the data migration system 102. As the system 102 provides the information necessary for troubleshooting, the monitor 104 is not required to access to the computer network or the data migration system 102 to obtain the information. This setup obviates the need for remote access to potentially sensitive information regarding the system 102, reducing vulnerabilities which an unauthorized user may exploit to gain access to the system 102. Furthermore, this setup ensures that the monitor 104 does not possess access to the data stored within the computer network, preserving the confidentiality of the data stored within the system 102.

In a further aspect of the system 102, discussed in greater detail below, the administrator of the system 102 may pre-select the information which is provided in the report to the monitor 104. Thus, information regarding selected elements, log files, configurations, and other information may be omitted from the report. As a result, the monitor 104 may be provided with limited information for initial problem solving and, at the administrator's discretion, provided additional information as necessary.

One embodiment of the storage operation cells 106 of the system 102 are illustrated in FIG. 1. The storage operation cells 106 may include combinations of hardware, software, and firmware elements associated with performing data migration operations on electronic data, including, but not limited to, creating, storing, retrieving, and migrating primary data copies and secondary data copies. One exemplary storage operation cell 106 may comprise CommCells, as embodied in the QNet storage management system and the QiNetix storage management system by CommVault Systems of Oceanport, N.J.

In one embodiment, the storage operation cells 106 may comprise a plurality of elements such as storage managers 110, client computers 112, media agents 114, and primary and secondary storage devices 116A, B (collectively, 116), as discussed in greater detail below. It may be understood that this list is not exhaustive and that the number of these and other elements present or absent within the cell 106 may be provided as necessary for the data migration operations performed by the cell 106. In some embodiments, certain elements reside and execute on the same computer, while in alternate embodiments, the some or all of the elements reside and execute on different computers.

The storage manager 110 comprises a software module or other application which coordinates and controls data migration operations performed by the storage operation cell 106. These operations may include, but are not limited to, initiation and management of production data copies, production data migrations, and production data recovery. To perform these operations, the storage manager 110 may communicate with some or all elements of the storage operation cell 106. The storage manager 110 may also maintain a database 120 or other data structure to indicate logical associations between elements of the cell 106, for example, the logical associations between media agents 114 and storage devices 116 as discussed below.

In one embodiment, the media agent 114 is an element that instructs a plurality of associated storage devices 116 to perform operations which subsequently archive, migrate, or restore data to or from the storage devices 116 as directed by the storage manager 110. For example, the media agent 114 may be implemented as a software module that conveys data, as directed by the storage manager 110, between a client computer 112 and one or more storage devices 116, such as a tape library, a magnetic media storage device, an optical media storage device, or other suitable storage device. In one embodiment, media agents 114 may be communicatively coupled with and control a storage device 116 associated with that particular media agent 114. A media agent 114 may be considered to be associated with a particular storage device 116 if that media agent 114 is capable of routing and storing data to that storage device 116.

In operation, the media agent 114 associated with a particular storage device 116 may instruct the storage device 116 to use a robotic arm or other retrieval mechanism to load or eject certain storage media, and to subsequently archive, migrate, or restore data to or from that media. Media agents 114 may communicate with a storage device 116 via a suitable communications link 130, such as a SCSI or fiber channel communication

The media agent 114 may also maintain an index cache, database, or other data structure 120 which stores index data generated during data migration, migration, and restore and other data migration operations that may generate index data. The data structure 120 provides the media agent 114 with a fast and efficient mechanism for locating data stored or archived. Thus, in some embodiments, the storage manager database 120 may store data associating a client 112 with a particular media agent 114 or storage device 116 while database 120 associated with the media agent 114 may indicate specifically where client 112 data is stored in the storage device 116, what specific files are stored, and other information associated with the storage of client 112 data.

In one embodiment, a first storage operation cell 106A may be configured to perform a particular type of data migration operation, such as storage resource management operations (SRM). SRM may comprise operations include monitoring the heath, status, and other information associates with primary copies of data (e.g. live or production line copies). Thus, for example, the storage operation cell 106A may monitor and perform SRM related calculations and operations associated with primary copy data. The first storage operation cell 106A may include a client computer 112 in communication with a primary storage device 116A for storing data directed by the storage manager 110 associated with the cell 106A.

For example, the client 112 may be directed using Microsoft Exchange data, SQL data, Oracle data, or other types of production data used in business applications or other applications stored in the primary volume. The storage manager 110 may contain SRM modules or other logic directed to monitor or otherwise interacting with the attributes, characteristics, metrics, and other information associated with the data stored in the primary volume.

In another implementation, a storage operation cell 106B may also contain a media agent 114 and secondary storage volume 116B configured to perform SRM related operations on primary copy data The storage manager 110 may also track and store information associated with primary copy migration. In some embodiments, the storage manager 110 may also track where primary copy information is stored, for example in secondary storage.

In alternative implementations, the storage operation cell 106B may be directed to another type of data migration operation, such as hierarchical storage management (HSM) data migration operations. For example, the HSM storage cell may perform production data migrations, snapshots or other types of HSM-related operations known in the art. For example, in some embodiments, data is migrated from faster and more expensive storage such as magnetic storage (i.e. primary storage) to less expensive storage such as tape storage (i.e. secondary storage).

The storage manager 110 may further monitor the status of some or all data migration operations previously preformed, currently being performed, or scheduled to be performed by the storage operation cell 106. In one embodiment, the storage manager 110 may monitor the status of all jobs in the storage cells 106 under its control as well as the status of each component of the storage operation cells 106. The storage manager may monitor SRM or HSM operations as discussed above to track information which may include, but is not limited to: file type distribution, file size distribution, distribution of access/modification time, distribution by owner, capacity and asset reporting (by host, disk, or partition), availability of resources, disks, hosts, and applications. Thus, for example, the storage manager 110 may track the amount of available space, congestion, and other similar characteristics of data associated with the primary and secondary volumes 116A, B, and issue appropriate alerts to the reporting manager 100 when a particular resource is unavailable or congested.

The storage manager 110 of a first storage cell 106A may also communicate with a storage manager 110 of another cell, such as 106B. In one example, a storage manager 110 in a first storage cell 106A communicates with a storage manager 110 in a second cell 106B to control the storage manager 110 of the second cell 106B. Alternatively, the storage manager 110 of the first cell 106A may bypass the storage manager 110 of the second cell 106B and directly control the elements of the second cell 106B.

In further embodiments, the storage operation cells 106 may be hierarchically organized such that hierarchically superior cells control or pass information hierarchically to subordinate cells and vice versa. In one embodiment, a master storage manager 122 may be associated with, communicate with, and direct data migration operations for a plurality of storage operation cells 106. In some embodiments, the master storage manager 122 may reside in its own storage operation cell 128. In other embodiments, (not shown), the master storage manager 122 may itself be part of a storage operation cells 106.

In other embodiments, the master storage manager 122 may track the status of its associated storage operation cells 106, such as the status of jobs, system elements, system resources, and other items by communicating with its respective storage operation cells 106. Moreover, the master storage manager 122 may track the status of its associated storage operation cells 106 by receiving periodic status updates from the cells 106 regarding jobs, elements, system resources, and other items. For example, the master storage manager 122 may use methods to monitor network resources such as mapping network pathways and topologies to, among other things, physically monitor the data migration operations.

The master storage manager 122 may contain programming or other logic directed toward analyzing the storage patterns and resources of its associated storage cells 106. Thus, for example, the master storage manager 122 may monitor or otherwise keep track of the amount of resources available such as storage media in a particular group of cells 106. This allows the master storage manager 122 to determine when the level of available storage media, such as magnetic or optical media, fall below a selected level, so that an alert may be issued to the reporting manager 110 that additional media may be added or removed as necessary to maintain a desired level of service.

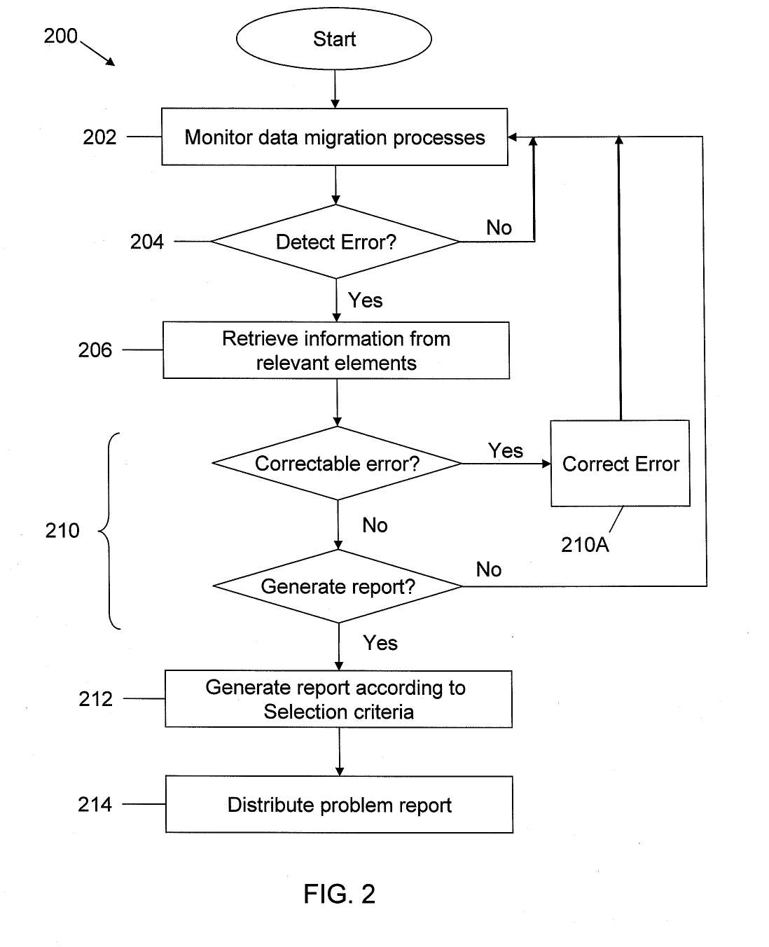

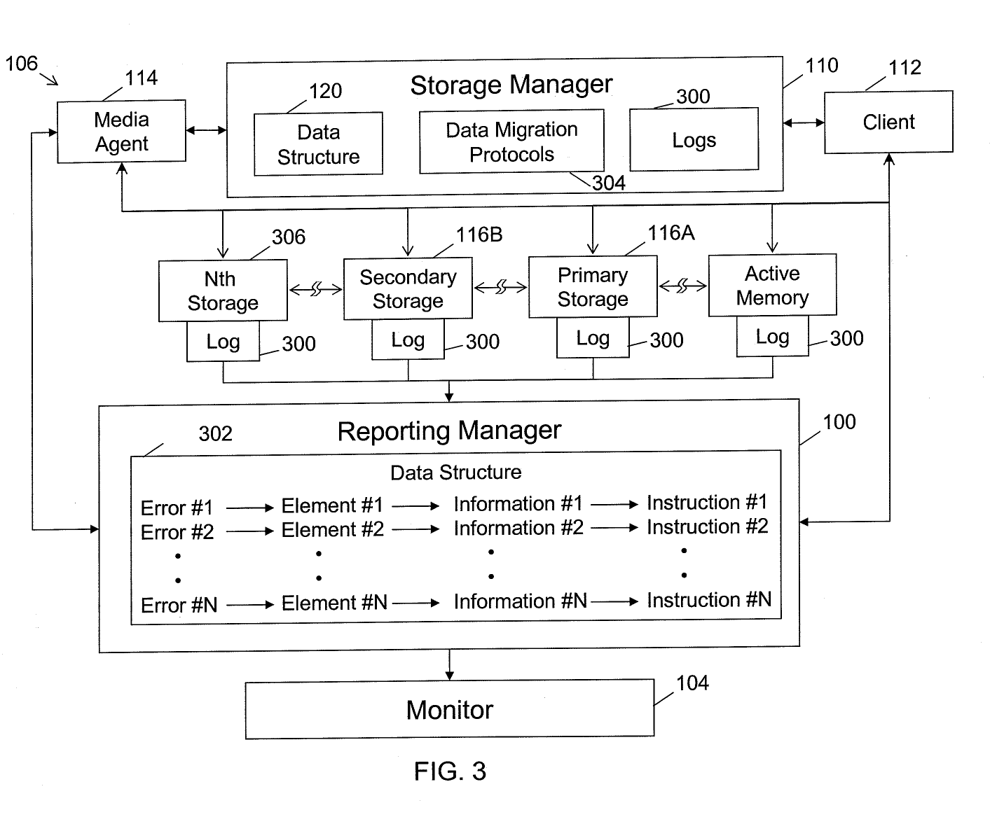

FIGS. 2-3 present diagrams illustrating of one embodiment of a method 200 of automated problem reporting (FIG. 2) and the interaction of the reporting manager 110 with a storage operation cell (FIG. 3) monitored by the reporting manager 110. In a first step 202, the reporting manager 110 monitors a plurality of data migration processes occurring within the cell. In a second step 204, the reporting manager 110 detects at least one failure occurring in the data migration process. In a third step 206, information is requested and obtained pertaining to all elements involved in a failed data migration process. In a fourth step 210, the information is analyzed in order ascertain the nature of the problem. In a fifth step 212, the problem report is generated, based upon selection criteria provided by the administrator of the data migration system. In a sixth step 214, the problem report is disseminated to the remote monitor 104.

In the first step 202, the automated reporting manager 100 monitors data migration operations performed within the entire system, as well as the status of the system elements. In general, this monitoring may observe both SRM operations on primary copy information and HSM operations on secondary copy information, as well as the communication between storage cells and, if hierarchically organized, between the cells and the master storage manager.

An example data migration operation may be one performed according data migration protocols 304 specified by the administrator. These protocols 304 are maintained by the storage manager 110 and may specify when to perform data migration operations, which data is to be migrated, where the data is to be migrated, and how long data will be retained before deletion. For example, a protocol 304 may specify that a specific type of data is to be retained in primary storage for a selected number of weeks from creation before migration to secondary storage, retained in secondary storage for a selected number of months before migrating to lower level storage 306 and retained in lower level storage for a selected number of years, at which point the data is deleted. Alternatively, the data migration operation may be performed in response to a request for archived information by the client 112. In either case, the data structure 120 maintains a record of the media agent 114 which is responsible for tracking the location of the data. At each stage in the data migration process, the elements may also generate logs 300 or log entries which maintain a record of the data migration and retrieval operations they perform.

In the second step 204, the reporting manager 110 detects an error which has previously occurred, or is currently occurring, in one or more data migration operations or elements of the system. In this process, the reporting manager 100 may communicate with any combination of elements of the system, such as storage managers 110, clients 112, media agents 114, storage devices 116, or data structures 120, as necessary. The elements of the system are also provided with programming or other logic which return an appropriate error when an operation fails to be properly performed. The reporting manager 110 may detect these errors by actively monitoring the logs 300 for errors. Alternatively, the errors may be communicated to the reporting manager 110 by any of the elements of the system 102, either singly or in combination. The reporting manager 110 may additionally monitor element hardware, software, and firmware status and configurations, as well communication links, to ascertain if communication errors, hardware, software, firmware, or configurations unrelated to the data migration operation, are responsible for errors.

In the third step 206, the reporting manager 110 gathers the relevant information from the elements on detection of an error. In one embodiment, the reporting manager 110 utilizes a data structure 302 containing lookup tables that correlates the detected errors with the appropriate elements involved in the problem. The data structure 302 may further provide the reporting manager 110 with a list of the information that is to be gathered from the elements in conjunction with the error.

In the fourth step 210, the reporting manager 110 determines whether a problem report should be generated. In one embodiment, the reporting manager 110 may utilize programming or other logic to perform content based analysis on the gathered information to make this determination. For example, the reporting manager 110 may be configured to parse the logs 300 to determine selected key strings, such as error codes and tokens, while the data structure 302 may be further configured to contain instructions regarding a course of action for each error. When detecting an error, the reporting manager 110 may review the data structure 302 in light of the error codes to determine the appropriate course of action. For example, when detecting a common error that may be corrected in a step 210A by the system without human intervention, the reporting manager 110 may be instructed to ignore the error and return to monitoring the data migration process from step 202. Alternatively, when detecting an error that may not be corrected in step 210A or repeatedly occurs over a selected time window, the reporting manager 110 may be instructed to report the error, continuing to step 212. Advantageously, this allows the reporting manager 110 to issue reports on true failure problems that require the attention of the monitor, rather than routine errors which are readily resolved by the system itself.

Use of the data structure 302 by the reporting manager 110 may also allow the prioritization of reports. The data structure 302 may further contain a selected priority rating associated with the errors which it recites, with serious problems provided a high priority and trivial problems provided a low priority. Thus, when the monitor receives a report, the report may be sorted into an ordered queue for resolution based on its priority. Beneficially, this priority rating ensures that the most serious reported problems are highlighted for attention, based on their severity, and not left unattended during the resolution of less severe problems.

In a fifth step 212 of the method 200, the report may be generated according to selection criteria provided by the administrator. As discussed in greater detail below, the reporting manager 110 provides a graphical user interface which allows the administrator to select the portions of the collected information provided in the report. Filtering based upon a job ID, the relevant elements, and a selected time period, as well as element error logs, crash dumps, and configurations and other criteria may be utilized.

In a sixth step 214 of the method 200, the reporting manager 110 generates the report. In one embodiment, the report comprises a plurality of files which provide the information selected by the data migration system administrator, discussed below. In general, the report may comprise combinations of text files, xml, and html files, cabinet files, and other file types appropriate for providing the information requested by the reporting manager 110. Alternatively, an administrator of the data migration system may also initiate the generation of a problem report at their discretion.

In one embodiment, the report may contain a text file or other appropriate file which provides a summary of the collected information. The summary may include the job ID and failure reason of the failed process, if a job ID option is selected for reporting along with a subject, as discussed in greater detail below. The summary may additionally comprise the cell ID (such as a Commcell ID for a cell within the CommVault GALAXY system), element name, operating system, platform, time zone, version of the data migration system software, and IP address.

Another portion of the report may comprise a collection of files pertaining to each client 112. In a non-limiting example, the files may include combinations of one or more of the following: data migration system logs (such as those provided by the CommVault GALAXY system), element hardware, software, and firmware configurations, system logs, crash dumps, and registries (such as those provided by the CommVault GALAXY system). In a preferred embodiment, the GALAXY registries are included by default, with other information provided optionally, at the administrator's discretion. In one embodiment, if the administrator selects to report the job ID or filter the information presented in the report by time, as discussed below, the reported log lines may be sent by the clients to the reporting manager in plain text and combined into a single file for inclusion in the report. Optionally, a log file for each client may be provided, rather than combined into a single file.

Another portion of the report may optionally comprise a fingerprint, in an xml format. The fingerprint provides a unique identifier that allows the system to distinguish between the machines which are being reported on. Any generally understood fingerprint may be utilized, such as the serial numbers of hardware or software present in the machines (e.g. CPU, hard disk drive, volume creation date, or operating system), addresses (e.g. MAC address of the network adapter of the machines, network address) or combinations thereof.

An additional component of the log bundle may optionally comprise database dumps. In general, a database dump contains a record of the table structure and/or the data from a database. In one embodiment, the database dump may be in the form of list of SQL queries. The database dump may be utilized in order to restore the contents of a database in the event of data loss. For example, corrupted databases can often be recovered by analysis of the dump.

A further component of the report may optionally comprise SQL_ERROR_LOGS.CAB, a cabinet file which contains all files with the name ERRORLOG.<NUM> as discussed above.

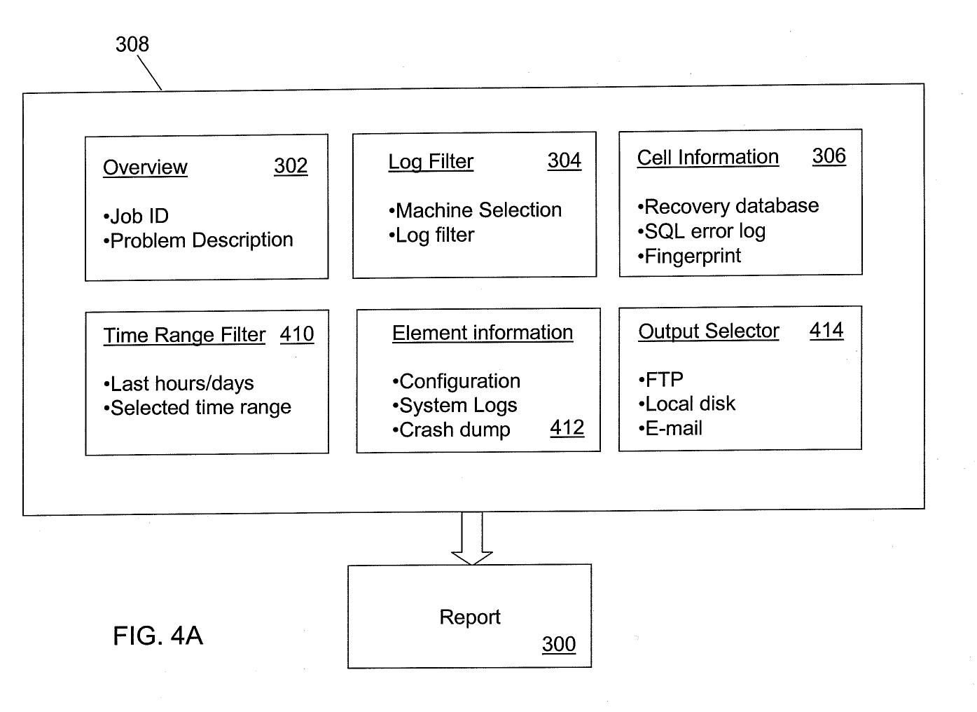

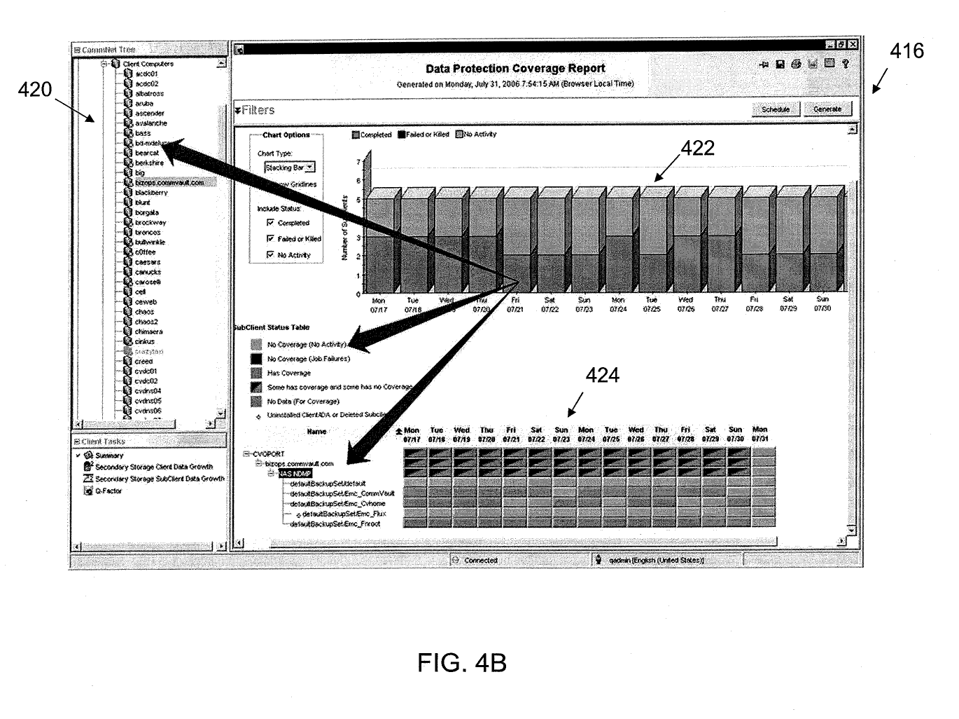

In the sixth step 214 of the method 200, the report is issued to the remote monitor 104. The remote monitor 104, in one embodiment, comprises a plurality of computer professionals capable of troubleshooting problems arising in the data migration system who reside in one or more locations removed from the physical location of the data migration system. As discussed in greater detail below in FIG. 4, the report may be provided to the monitor 104 through a variety of mechanisms, including upload to an ftp site, upload to a local directory, a plurality of e-mail messages, fax, and telephone messages, depending on the severity of the problem. For example, in the case of a relatively minor problem, the report may be provided through at least one of e-mail, ftp, and local upload. In the case of more severe problems, telephone messages may be further added. The monitor 104 may read at least a portion the report to ascertain the nature of the problems which triggered the report or utilize another program to analyze the report in part or in total. Upon ascertaining possible causes for the problems, appropriate actions may be taken for problem resolution.

In one embodiment, the monitor 104 does not possess access privileges to the data migration system. The monitor 104 thus operates in a support capacity, analyzing the problem report and suggesting possible courses of action to those locally who possess access privileges and/or physical access to the system locally. Advantageously, this system design allows an administrator of the data migration system to employ the remote monitor 104 for support without compromising the security of the data migration system or computer network by allowing remote access. Furthermore, as discussed in greater detail below, the report does not contain any information on the data within the computer network and administrator may limit information the reporting manager provides regarding the data migration system in the report, further enhancing the security of the system.

In an alternative embodiment, the monitor 104 may possess a selected level of remote access privileges to the data migration system. This access allows the monitor to use the report as a starting point for problem resolution, isolating possible causes, and allowing the monitor 104 to execute solutions remotely. Advantageously, this setup may be appropriate for systems requiring only low security. For example, in a small business without a local computer professional, the automated report could assist a remote monitor 104 in identifying problems which they could subsequently fix, without the need for the small business owner to contract for a local computer professional, reducing the cost of maintaining the data migration system.

FIG. 4A illustrates one schematic embodiment of a graphical user interface 408 of the data migration system which allows an administrator of the data migration system to select from various options in preparation of a report 400. In general, the interface 408 allows the system administrator to select, in advance of report generation, how the reporting manager will assemble the information provided to the remote monitor. It may be understood that the report 400 may contain any combination of the options discussed below. Further, the report is not limited to these options but may be expanded, as necessary, through hardware, software, and firmware improvements to the automated reporting system.

It may be further understood that the report may also be arbitrarily generated by the administrator's discretion. For example, the administrator may schedule periodic report generation in the absence of detected errors in order to provide selected information regarding the hardware, software, and firmware of the data migration system to the remote monitor.

In one embodiment, the interface 408 includes tabbed windows, dividing the selectable report parameters into broad sections. Advantageously, this interface 408 enhances the ease with which the administrator may customize the report. In a non-limiting embodiment, the sections, discussed in greater detail below, may comprise: an overview 402, a log summary 404, cell information 406, a time range filter 410, element information 412, and an output selector 414. In the discussion, below, the sections of the report 400 and the tabbed windows of the interface 408 are referred to interchangeably, as the selections within the interface 408 give rise to the sections presented in the report 400.

The overview 402 of the report 400 provides the monitor a summary of the problems which prompted the generation of the report. The overview 402 may include a subject which comprises a unique ticket number or job ID which identifies the particular data migration process which failed. The overview 402 may further comprise a description of the problem, as determined by analysis of the information received from the cells. The description may stress specific information needed for troubleshooting, which may include, but is not limited to, combinations of specific hardware, software, and firmware involved in the data migration problem, the specific data migration process which has failed, and communication link problems within the system. Advantageously, the overview 402 allows the monitor to quickly ascertain the specific reasons for the problem report rather than requiring laborious analysis of the log files generated by the selected elements. Thus, problem resolution is hastened by the automated problem reporting manager.

The log window 404 provides the administrator control over the logs provided to the monitor, as illustrated in FIG. 4. These logs may comprise any of the logs generated by the elements during data migration operations. In general, the logs comprise lists of data migration operations performed, containing information which may include, but is not limited to, a job ID for the operation, a cell ID for the cell in which the operation was performed, a element ID for the elements on which the operation was performed, and acknowledgement that the job was completed. In one embodiment, the logs may comprise logs generated by the CommVault GALAXY system.

In one embodiment, the administrator may use the log window 404 to filter the logs provided to the monitor in the report. For a monitor to review all the logs of all the elements involved in the data migration system for problem resolution would be a significant, time consuming task, as much of the content of the logs may not be relevant to the problem at hand. Furthermore, the logs may reveal information about the data migration system or computer network which the administrator may not wish to be disseminated. Thus, to save time and resources, as well as improve the security of the data migration system, the administrator may select from several options for how the logs are filtered for reporting to the monitor.

In one embodiment, the administrator may select which elements are included in the report. For example, the customer may wish to omit information regarding a particular computer for security reasons. Alternatively, the administrator may generally have reason to believe that logs from certain elements do not need to be reported. Choosing this option, all of the log files generated by the data migration system from the selected elements will be provided, such as GALAXY logs.

In further embodiments, the logs may be provided based on the job IDs they contain. When this option is selected, the reporting manager searches the logs of the elements for specific job ID numbers. Then, the reporting manager includes only the log lines related to the job ID in the report.

Advantageously, the job ID and element filters allow the administrator significant flexibility in tailoring the logs provided to the monitor. For example, if problems which occur throughout the data migration system are a concern, the administrator may select to allow all logs from all monitored elements involved in the failure process. Alternatively, if security is a primary concern, the administrator may select to allow only log fragments from certain computers to be viewed by the monitor. The administrator may further loosen these restrictions in subsequent reports, as necessary, should the monitor require more information than provided. This flexibility allows the administrator to balance the amount of information released to facilitate problem evaluation and problem solving with security concerns.

In one embodiment, the cell window 406 allows the administrator to permit the reporting manager to provide information regarding a disaster recovery database in the report. At least a portion of this database may comprise meta-data regarding the client environment, or data regarding the data contained within the client environment. In the event that the client environment sufferers a problem, this database may be utilized to recreate the client environment in a properly operating state.

The cell window 406 may further allow the administrator the option to include SQL error logs in the report. The errors logged may generally comprise system and user-defined events which occur on an SQL server, and more specifically, errors in data retrieval operations in SQL Server. In one non-limiting example, a Microsoft SQL server using the CommVault QiNetix system may provide all files with the name ERRORLOG.<NUM>, where <NUM> is the number of the selected error log, under SQL path retrieved by the registry SOFTWARE\\Microsoft\\Microsoft SQL Server\\COMMVAULTQINETIX\\Setup\\SQLPath.

The cell window 406 may further contain fingerprints, as discussed above, for the machines discussed in the report.

The time range section 410 allows the administrator to filter the report 408 based on a selected time period. In one embodiment, the time range filtering is optional, and may be disabled when the administrator elects to provide logs by job ID, as discussed above. In another embodiment, the time range may comprise a selected time period prior to generation of the report 400, such as the last 24 hours. In an alternative embodiment, the administrator may provide information in the report over a selected, arbitrary time range.

Time filtering allows the administrator further control over the information provided to the remote monitor. In one embodiment, this mechanism of filtering may be useful when problems are most easily tracked and solved chronologically. In an alternative embodiment, an administrator may provide logs relevant to a particular time to a monitor experienced in solving the type of problem occurring over that time period. Dividing the log in this manner allows troubleshooting resources to be allocated by the administrator where they are needed. In a further embodiment, in the case where multiple monitors work on a problem, time filtering may be used to divide the problem report into sections based on a time period such that monitors may only be provided pieces of the problem, giving the administrator greater control over security of the report information.

The element information section 412 of the interface 408 further allows the administrator to provide information specific to the elements involved in the failed data migration operation such as element hardware, software and firmware configurations, system logs, and crash dumps. Non-limiting examples of the element hardware, software, and firmware configurations are: processor type, processor speed, operating system, physical memory, available memory, available virtual memory, element name, IP address, time zone, and the version of the data migration software operating on the element. Non-limiting examples of system logs are: System/Application Event Logs (Microsoft Windows), /var/adm/messages* and /etc/system (Sun Microsystems Solaris), “errpt -a” output (IBM AIX), files similar to /etc/system (Linux and HP-UX) and abend logs (Novell Netware). Non-limiting examples of the crash dump information are the Dr. Watson log (Microsoft Windows) and a list of core files and the name of the executables which caused the core (Unix). Advantageously, this element information allows the monitor to determine if hardware or software associated with the element operation, as separate from the data migration process, may be responsible for data migration problems.

The output selector 414 allows the administrator to determine the manner in which the report 408 is provided to the remote monitor. In one embodiment, the output may comprise at least one of upload to an FTP location, an electronic mail message with the subject line of the job ID or ticket number, and saving to a local directory. Advantageously, this flexibility in the delivery mechanism of the report 400 allows the report 400 to be provided in the manner which is most appropriate to the circumstances of the data migration system. For example, if one line of communication is unavailable, inaccessible, or insecure, the report may still be provided, enhancing the robustness of the problem reporting manager.

In one embodiment, the output selector 414 further allows the administrator to select a size limit for the message which is sent containing the report. Often network bandwidth is limited from sending or receiving messages over a certain size. Further, depending on the nature of the problem within the system, the report 400 may be relatively large. Thus, when a limit is specified, the reporting manager may check the final report 400 size against the selected limit. If the size of the report 400 exceeds the limit, the report 400 may be split into multiple CAB files, each with a size less than the limit. In this case, multiple messages are then sent containing the smaller CAB files. Optionally, a utility may be provided to the remote monitor for re-assembly of the CAB files. Advantageously, this size flexibility enhances the robustness of the reporting system, ensuring that the e-mails are not delayed or rejected because of their size during their transmission or receipt.

FIG. 4B illustrates one embodiment of a graphical display 416 of at least a portion of the information contained within the report 300 received by the remote monitor, for example, coverage status. In one aspect, the display 416 contains a list 420 of the machines for which information is provided in the report. Selection of a machine on the list 420 causes information for that machine to be displayed. One set of information displayed may comprise jobs, or subclients, which are active on the selected machine. The report may provide a summary 422 of the number of jobs performed on the selected machine over a selected time period. The summary 422 may include, but is not limited to, the number of successfully completed jobs, number of failed jobs, number of inactive jobs. Display 416 may further provide a breakdown 424 of the status of the individual jobs over the selected time period.

### EXAMPLES

In the following examples, circumstances in which problem reports may be generated are discussed. In general, the examples illustrate the wide range of problems which may be automatically identified and reported through the use of embodiments of the automated problem reporting system and further illustrate how the problem report may be utilized by computer professionals to identify and resolve problems more quickly and easily than through conventional, manual problem resolution. These examples are discussed for illustrative purposes and should not be construed to limit the embodiments of the invention.

### Example 1

### Mechanical Failure

In one embodiment, the reporting manager may monitor or be alerted to the physical status of the elements of the data migration system and issue a problem report when a mechanical failure occurs. For example, media agents perform copy or restore operations in response to instructions from storage managers. The data to be archived or recovered may reside on media such as a tape or optical disk which is mechanically retrieved, for example using a mechanical arm, and loaded into a storage volume for access. This mechanical operation, however, may fail if the mechanical arm fails to properly actuate.

Should the mechanical arm fail to operate properly, the storage manager or media agent alerts the automated reporting manager which triggers generation of a problem report. The reporting manager may gather information regarding the storage volume and reporting manager, the element and cell containing the storage volume and storage manager, as well as associated logs. The reporting manager may then apply the reporting selections entered in the graphical user interface and issue the report. Depending on the level of specificity of the alert received by the reporting manager, the summary of the report may contain the job ID for the data migration function which has failed and a description stating that the storage volume at issue experienced a hardware problem.

Advantageously, the report may allow the monitor to quickly determine that a mechanical failure has occurred in one or more storage volumes by review of the summary and bundled files. On determination that the mechanical arm retrieving the media is the source of the problem, the monitor may then contact the data migration system administrator or other local computer professional to suggest remedies which the administrator may execute. Alternatively, if the monitor possesses sufficient access privileges, the monitor may perform problem resolution themselves. Examples of remedies may include scheduling the data migration operation to be performed on another storage volume, repairing or replacing the mechanical system which has failed, or canceling the data migration operation.

### Example 2

### Network Connectivity

In one embodiment, the reporting manager may monitor or be alerted to status of communications links which allow the elements of the data migration system to communicate with each other and the computer network which the data migration system services. For example, when a client requests files which are archived, the client computer communicates with a storage manager, which then issues instructions to the appropriate media agent to retrieve the requested data and transmit the data to the client computer. Often, these various functions are performed on different elements. Thus, should the communication links between the client and storage manager, the storage manager and media agent, or the media agent and client be disrupted due to hardware or software problems, the data migration operation may not be performed correctly.

Depending on the severity of the connectivity problem, a single instance, periodic instances, or consistently occurring, the automated reporting manager may trigger the generation of the problem report. The reporting manager gathers element information and appropriate logs from the media agent, storage manager, client computer, as well as element information and log files for the element where the reporting manager is located. The reporting manager may then apply the reporting selections entered in the graphical user interface and issue the report. Should the reporting manager encounter difficulties connecting to one or more elements, information from those elements may also be included in the problem report. The summary of the report may contain the job ID for the scheduled retrieval function and a description stating that a network connectivity problem is at issue.

In this manner, the monitor is quickly made aware that the problem at issue may at least be network connectivity. The monitor, depending on their degree of access to the data migration system, may then contact the data migration system administrator to suggest remedies for the storage deficiency which the administrator may execute or perform problem resolution themselves. Examples may include checking the network configuration within the operating system and data migration software of the elements involved in the failed process as well as checking the status of the network hardware and physical network connections of the same.

### Example 3

### Acknowledgement Failure

In one embodiment, the reporting manager may monitor or be alerted to status of data migration operations which are conducted between elements. As described above, agents such as the media agents are responsible for executing data migration operations designated by the storage manager. When data is migrated, under normal operation, the relevant agent receives instruction from the storage manager, identifies the location of the data from the relevant database, performs the designated migration operation, updates the location of the migrated data in the agent database for later reference, and provides an acknowledgement of the operation to the storage manager and/or other monitoring elements.

In the event that one or more steps in this process are not successfully completed, the media agent may fail to acknowledge the completion of the data migration operation and the reporting manager may generate a problem report. The reporting manager may contact the media agent and the storage device to obtain the log files and element hardware, software, and firmware configurations for the elements containing the media agents involved in the failed process and the element containing the reporting manager. Subsequently, the reporting manager applies programming or other logic to the received information to determine the problem, applies the selection criteria entered in the graphical user interface for reporting, and issues the problem report. The summary of the report may contain the job ID for the scheduled data migration operation and a description stating that an acknowledgement failure is at issue.

In this manner, the monitor is quickly made aware that the problem at issue may concern the acknowledgement reporting. The monitor, depending on their degree of access to the data migration system, may then contact the data migration system administrator to suggest remedies for the storage deficiency which the administrator may execute or perform problem resolution themselves. For example, the received information on the media agent and storage device may be reviewed to determine if an identifiable hardware or software failure has occurred in either element. Examples of checking hardware errors may include examining the network connectivity of the media agent and storage device and the mechanical status of the storage device as discussed above. Examples of checking software errors may include examining the file system for problems, such as corrupted databases, a file pathway which cannot be determined, or other problems opening or writing files and directories, as well as incompatibilities between the server a restore is attempted on and the server the files originated from

### Example 4

### Problem Prediction

In one embodiment, the problem reporting system may also issue problem reports based upon predicted problems. For example, the data migration system may issue an alert when predicting that a storage volume may reach a selected fraction of its capacity. An element of the data migration system, such as a storage manager, master storage manager, or reporting manager, may record the rate at which data are stored on a storage volume and/or have access to historical records of the same and also monitor of the capacity of storage volumes within the data migration system. For example, the reporting system may be aware that a data migration operation is scheduled on a selected day in the future on a selected volume. The system may, based upon trends in storage usage and the present capacity of the storage volume, may predict the available storage capacity on the selected day and determine if the size of the scheduled backup exceeds the space predicted to be available.

Should insufficient space be available, the automated reporting manager may trigger the generation of the problem report. The reporting manager may gather information from the storage volume, the element containing the storage volume, the cell containing the storage volume, associated logs, as well as element information and log files for the element where the reporting manager is located. The reporting manager may then apply the selections entered in the graphical user interface for reporting and issue the report. The summary of the report may contain the job ID for the scheduled data migration function and a description stating that the storage volume at issue may not possess sufficient capacity for the data migration.

Advantageously, this predictive capability allows problems to be prevented before they occur. The summary description may allow the monitor to quickly determine that the storage capacity of one or more storage volumes is the cause of the problem report, rather than reviewing a large amount of log files to determine the same. On determination of the problem, the monitor, depending on their degree of access to the data migration system may then contact the data migration system administrator to suggest remedies for the storage deficiency which the administrator may execute or perform problem resolution themselves. Examples may include scheduling the data migration operation to be performed on another storage volume, installing a new storage volume, deleting unnecessary files on the storage volume to provide additional capacity, or canceling the data migration operation.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A method of problem reporting in a computer network, comprising:
monitoring a plurality of elements which perform data migration operations;
detecting a problem which occurs during the data migration operations;
requesting information from the elements;
assembling the requested information into a report; and
providing the report to a monitor which does not possess access privileges to the elements.

2. The method of claim 1, wherein the data migration operations comprise at least one of storage resource management operations and hierarchical storage management operations.

3. The method of claim 1, wherein the report is generated automatically upon detection of a problem.

4. The method of claim 1, wherein the elements comprise at least one of a storage manager, media agent, client computer, and storage media.

5. The method of claim 1, wherein the problem is detected by review of at least one of log files generated by the elements, the status of communication links between the elements, and hardware, software, and firmware configurations of the elements.

6. The method of claim 5, wherein the problem is detected by discovery of error messages issued by the elements.

7. The method of claim 6, further comprising analysis of the issued error messages to determine the information to be requested.

8. The method of claim 7, further comprising analysis of the requested information in order to determine whether a report should be generated.

9. The method of claim 1, wherein the requested information comprises at least one of log files generated by the elements, status of communication links between the elements, and hardware, software, and firmware configurations of the elements.

10. The method of claim 9, wherein the information provided in the report comprises a portion of the requested information based upon selection criteria provided by an administrator of the elements.

11. The method of claim 1, wherein the report is provided by at least one of the following mechanisms: electronic messaging, storage in a storage device within the computer network, storage in an FTP server, and telephone calls.

12. The method of claim 1, wherein the report is prioritized according to a selected severity of the problem so as to provide the monitor an ordered queue of reports.

13. A method of remotely monitoring data migration operations within a computer network, comprising:
providing a plurality of elements, comprising at least one of hardware, software, and firmware components, which perform data migration operations;
monitoring at least one of log files generated by the elements, communications links between the elements, and configurations of the elements during the data migration operations to detect errors in data migration operations;
gathering and analyzing selected information from the monitored elements automatically in response to the detection of an error in a data migration operation; and
communicating the selected information to a remote monitor.

14. The method of claim 13, wherein the data migration operations comprise at least one of storage resource management operations and hierarchical storage management operations.

15. The method of claim 13, wherein the remote monitor does not possess access privileges to the elements.

16. The method of claim 13, wherein the error is detected by the discovery of error messages issued by the elements within the monitored information.

17. The method of claim 16, further comprising analysis of the detected error to determine the information to be gathered.

18. The method of claim 17, further comprising cross-referencing the detected error with a data structure that contains instructions regarding courses of action for at least some of the errors in the data migration operations in order to determine whether the selected information should be communicated to the remote monitor.

19. The method of claim 13, wherein the information provided in the report comprises a portion of the requested information based upon selection criteria provided by an administrator of the elements.

20. The method of claim 13, wherein the report is provided by at least one of the following: electronic messaging, storage in a storage device within the computer network, storage in an FTP server, and telephone calls.

21. The method of claim 13, wherein the error is detected after the error occurs.

22. The method of claim 13, wherein the selected information is prioritized according to a selected severity of the problem so as to provide the monitor an ordered queue of information.

23. A system for remote monitoring of a data migration operation occurring within a computer network, comprising:
a plurality of elements which perform data migration operations; and
a reporting manager which communicates with the elements to detect problems occurring within data migration operations;
wherein the reporting manager gathers information from the elements in response to a detected problem and wherein at least a portion of the gathered information is provided to a remote monitor which does not possess access privileges to the elements.

24. The system of claim 23, wherein the data migration operations comprise at least one of storage resource management operations and hierarchical storage management operations.

25. The system of claim 23, wherein the elements comprise at least one of a plurality of storage managers, a plurality of media agents, a plurality of client computers, and a plurality of storage media.

26. The system of claim 23, wherein the reporting manager monitors log files generated by the elements, the status of communication links between the elements, and hardware, software, and firmware configurations of the elements to detect problems in the data migration operations.

27. The system of claim 23, wherein the elements communicate errors to the reporting manager to provide detection of a problem within the storage data migration operation.

28. The system of claim 23, wherein the gathered information comprises at least one of log files generated by the elements, the status of communication links between the elements, and hardware, software, and firmware configurations of the elements.

29. The system of claim 28, wherein at least a portion of the gathered information is provided to the remote monitor based upon selection criteria provided by an administrator of the elements.

30. The system of claim 23, wherein the reporting monitor assembles and provides the report without human intervention.

31. The system of claim 23, wherein the report is provided to the remote monitor by at least one of the following: electronic mail, storage in a storage device within the computer network, storage in an FTP server, and telephone calls.

32. An automated problem reporting data migration system, comprising:
a client computer containing data;
a plurality of storage media for storing the data;
a storage manager which coordinates data migration between any combination of any client computers and storage media;
a media agent which performs data migration operations in response to instructions from the storage manager; and
a reporting manager which monitors data migration operations and generates reports containing selected information regarding the system hardware, software, and firmware in response to errors occurring during data migration;
wherein the reports are provided to a remote monitor which does not possess access privileges to the data migration system.

33. The system of claim 32, wherein the data migration operations comprise at least one of storage resource management operations and hierarchical storage management operations.

34. The system of claim 32, wherein the information monitored during the data migration operation comprises at least one of file type distribution, file size distribution, distribution of access time, distribution of modification time, distribution by owner, capacity of storage media, asset reporting by host, disk, or partition, and availability of resources, disks, hosts, and applications.

35. The system of claim 32, wherein the storage manager monitors the capacity of the storage media and alerts the reporting manager when the level of available storage media is less than a selected level.

36. The system of claim 32, wherein the storage media are hierarchically organized.

37. The system of claim 32, wherein the storage media comprise at least one of RAM, magnetic media, and optical media.

38. The system of claim 32, wherein the report comprises at least one of log files generated by a data migration software application, hardware configuration, software configuration, firmware configuration, operating system log files, crash dumps, and registries.

39. The system of claim 38, wherein the operating system log files comprise at least one of Microsoft Windows System/Application Event Logs, Sun Microsystems Solaris /etc/system ( ) and /var/adm/messages*, IBM AIX “errpt -a” output, Linux or HP-UX files generated in /etc/system, and Novell Netware abend logs ( ).

40. The system of claim 38, wherein crash dump files comprise at least one of the Microsoft Windows Dr. Watson log and a list of Unix core files and names of executable files which caused the core.

41. The system of claim 32, further comprising a data structure that contains instructions regarding courses of action for at least some of the errors occurring during data migration.

42. The system of claim 41, wherein the reporting manager cross-references the errors with the data structure to determine whether a report should be provided to the remote monitor.
